(19) United States
(12) Patent Application Publication
(10) Pub. No.: US 2005/0265418 A1
(43) Pub. Date: Dec. 1, 2005

(54) Surface-emitting laser with external cavity formed by a waveguide bragg grating

(76) Inventor: Dmitri E. Nikonov, Morgan Hill, CA (US)

Correspondence Address: TROP PRUNER & HU, PC, 8554 KATY FREEWAY, SUITE 100, HOUSTON, TX, 77024, US

(21) Appl. No.: 10/981,918

(22) Filed: Nov. 4, 2004

Related U.S. Application Data
(60) Provisional application No. 60/574,850, filed on May 27, 2004.

(51) Int. Cl. H01S 3/03

(52) U.S. Cl. 372/64

(57) ABSTRACT

A surface-emitting laser may be coupled to a waveguide that includes a Bragg grating that acts as an external cavity. The surface-emitting laser may be attached using surface mount techniques to the chip containing waveguides. The light of the laser can be coupled into the waveguide using an angled reflector. The Bragg reflector in the waveguide serves to stabilize the wavelength and to increase the power of the laser. Such integrated surface emitting laser can be used as a pump laser for a waveguide optical amplifier.

### CROSS-REFERENCE TO RELATED APPLICATION

This application claims the benefit of U.S. Provisional Application No. 60/574,850, filed May 27, 2004.

### BACKGROUND

This invention relates generally to surface-emitting lasers.

A surface-emitting laser is a laser whose beam is emitted perpendicularly to the wafer planar surface. In contrast, in an edge-emitting diode, the laser beam is emitted through an edge of a chip cut out of a wafer. A surface-emitting laser may have a more circular beam and may be tested before cutting the wafer. A disadvantage of surface-emitting lasers is their relatively lower power compared to edge-emitting lasers.

Surface emitting lasers typically consist of a layer of the active region (which emits the light) and the layers of a vertical cavity (which serve as reflectors and provide the feedback). The active region is typically composed of a set of quantum wells to enhance gain. The vertical cavity is typically composed of Bragg reflectors to provide high reflectivity.

The development of metropolitan optical fiber networks imposes more stringent requirements on the cost and functionality of optical components. Multiple channels experience power loss in multiple switching and routing components and arrive at a node with different powers. Thus, they need to be amplified separately to prevent loss of data. This more complex functionality drives migration from erbium-doped fiber amplifiers to waveguide amplifiers integrated on chip. It is more challenging to achieve high power in waveguide amplifiers, but they are more compact and have a potential to be significantly cheaper.

Erbium-doped amplifiers in the wavelength range of 1400 to 1620 nanometers use pump lasers with a wavelength around 980 nanometers or 1480 nanometers for their operation. Pump lasers are typically commercially available in a fully packaged form. Precise alignment is required for attachment of the laser to a transmission fiber and the entire structure may be packaged in a butterfly can. Thus, fiber also needs to be interfaced with the waveguides on an amplifier chip. The packaging may be expensive. In fact, the pump lasers are the most expensive component of the amplifier. Therefore, separately packaged lasers may not permit realization of the potential cost advantages of integrated waveguide amplifiers.

Integration of edge-emitting lasers in waveguides has been tried. However, the output beam of the edge-emitting laser is strongly elliptical and much smaller than a typical waveguide dimension. Besides, the alignment to the waveguide may involve etching terraces in the waveguide chip and fitting the height of the bonding to vertically position the laser beam. As a result, the coupling losses are relatively high and the process is relatively expensive.

Thus, there is a need for better ways to amplify signals for optical fiber networks.

### BRIEF DESCRIPTION OF THE DRAWINGS

FIG. 1 is an enlarged, cross-sectional view of one embodiment of the present invention.

### DETAILED DESCRIPTION

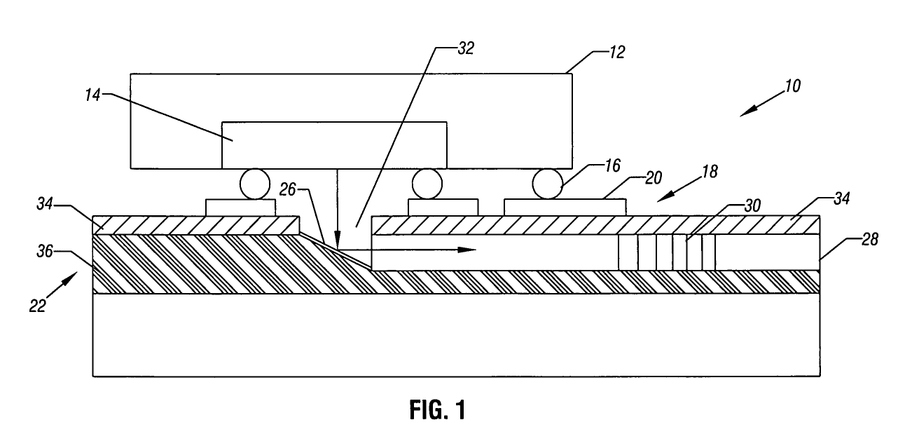

Referring to FIG. 1, a planar light circuit 10 includes a semiconductor substrate 24 that may have a layer 22, such as silica, formed thereon to define a waveguide amplifier. A waveguide 28 may be formed in the layer 22. In one embodiment, the waveguide 28 is erbium-doped and includes upper cladding 34 and lower cladding 36.

Also defined along the waveguide 28 is a trench 32 having an angled reflector 26 on one side. In one embodiment, the trench 32 may be formed by an angled etch, followed by coating the angled surface with a suitable reflective material.

Contacts 20 may be provided atop the layer 22. These contacts 20 may be surface mounted to an overlying surface-emitting pump laser die 14 by solder balls 16. In addition, a connection may be made through the contacts 20 and the solder balls 16 to a thermoelectric cooler 12 in one embodiment. The thermoelectric cooler 12 may cool the surface emitting pump laser die 14 during lasing. The cooler 12 and die 14 may be attached to the substrate 24 using surface mount techniques wherein heat is applied to soften the solder balls 16 to form a soldered connection.

Light emitted by the pump laser die 14, shining vertically through the trench 32 onto the reflector 26, is reflected horizontally into the waveguide 28. Because the waveguide 28 may be erbium-doped, the light may be amplified.

In addition, an external Bragg grating 30 may be provided in the waveguide 28. The Bragg grating 30 may stabilize the wavelength of the pump laser die 14 and may further allow a laser output power increase and may reduce power fluctuations. In one embodiment, the Bragg grating 30 may reflect the Bragg wavelength back into the die 14 for further amplification through wavelength selective reflection. In one embodiment, the Bragg grating 30 is adapted to provide an external cavity for the laser 14. The Bragg grating 30 may be written in a photosensitive waveguide (e.g. Germanium doped waveguide) by ultraviolet (UV) radiation.

Because of the external cavity effect obtained with the Bragg grating 30, lower cost surface-emitting lasers (rather than traditional edge emitting lasers) may be used as pump lasers for optical amplification. By surface mounting the laser die 14 on the waveguide, reduced cost may be achieved in some embodiments. Improved coupling efficiency may be achieved due to the use of a surface-emitting laser that has a circular output beam. A pick-and-place machine may be utilized to position the laser die 14 accurately over the waveguide 28, eliminating or reducing alignment problems. The effect of an external cavity can be achieved using the Bragg grating 30 in some embodiments, without the need to provide an extension to the surface-emitting laser that may unduly increase the size of the structure.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A device comprising:
a planar waveguide to receive the light from a surface-emitting laser; and
a Bragg grating formed in said waveguide, said grating to act as an external cavity for the laser.

2. The device of claim 1 including a surface-emitting laser over said waveguide.

3. The device of claim 2 wherein said surface-emitting laser is surface mounted onto said waveguide.

4. The device of claim 3 wherein said waveguide is a part of a planar lightwave circuit.

5. The device of claim 3 including a trench in said waveguide aligned to receive light from said laser.

6. The device of claim 5 including a reflector in said trench to reflect light from said laser into said waveguide.

7. The device of claim 6 wherein said waveguide is oriented at about 90 degrees to the incident laser light.

8. The device of claim 2 including a cooler for said laser.

9. A method comprising:
exposing a planar waveguide to light from a surface-emitting laser;
reflecting the light from the laser into said waveguide; and
providing an external cavity in said waveguide for said surface-emitting laser.

10. The method of claim 9 including surface mounting said laser on said planar waveguide.

11. The method of claim 9 including orienting the planar waveguide at approximately 90 degrees to the direction of incident laser light.

12. The method of claim 9 including forming a trench in said waveguide and forming a reflective surface in said trench to redirect said laser light from said waveguide.

13. A device comprising:
a planar lightwave circuit;
a die with a surface-emitting laser attached to said circuit;
a planar waveguide in said planar lightwave circuit, said waveguide including a reflector formed in said waveguide to act as an external cavity for said laser.

14. The device of claim 13 wherein the laser die is surface mounted to the planar lightwave circuit.

15. The device of claim 13 wherein the reflector is a Bragg grating formed in a waveguide.

16. The device of claim 13 also including an angled reflector formed in said planar light circuit to reflect light from said laser die into said waveguide.

17. The device of claim 13 including a trench formed in said planar light circuit, and said reflector formed in said trench.

18. The device of claim 13 wherein said waveguide is oriented at about 90 degrees to the incident laser light.

19. A method comprising:
surface mounting a surface-emitting laser on a planar light circuit;
forming a reflector on said circuit; and
forming a planar waveguide in said planar light circuit arranged to receive light reflected by said reflector.

20. The method of claim 19 also including forming a trench in said planar light circuit with an angled reflector to redirect the incident laser light.

21. The method of claim 19 also including forming a Bragg grating, to act as an external cavity, in said waveguide.

22. The method of claim 19 including orienting the planar waveguide at approximately 90 degrees to the direction of incident laser light.
